(19) United States
(12) Patent Application Publication
(10) Pub. No.: US 2025/0389376 A1
(43) Pub. Date: Dec. 25, 2025

(54) UTILITY HOLDER

(71) Applicants: John M. Tursky, Hillsborough, NJ (US); Harikrushna Patel, Secaucus, NJ (US)

(72) Inventors: John M. Tursky, Hillsborough, NJ (US); Harikrushna Patel, Secaucus, NJ (US)

(21) Appl. No.: 19/240,737

(22) Filed: Jun. 17, 2025

Related U.S. Application Data
(63) Continuation-in-part of application No. 19/063,113, filed on Feb. 25, 2025.
Application No. 19/063,113 is a continuation-in-part of application No. 18/825,150, filed on Sep. 5, 2024.
Application No. 18/825,150 is a continuation-in-part of application No. 18/747,848, filed on Jun. 19, 2024, now Pat. No. 12,458,162.

(51) Int. Cl. F16M 13/02; A47K 5/12

(52) U.S. Cl. CPC F16M 13/02; A47K 5/12

(57) ABSTRACT

A utility holder 100 for a soap dispenser comprises a fixture plate 300 adapted to be fixed to a wall. A sleeve 102 with a holder bracket 104 is adapted to be placed over the fixture plate 300. A sliding bracket 106 equipped with a ratchet 204 is configured to be inserted in the sleeve 102. Upon assembly, the fixture plate 300 is enclosed within the gap formed between the sleeve 102 and the sliding bracket 106, enabling the locking of the sliding bracket 106 via a locking mechanism 302. The locking mechanism 302 includes an elongated lever 306 with an integrally formed serpentine-shaped spring 308 and one or more apertures 310. The one or more apertures 310 are configured to couple with a movable magnetic block 304 that exerts a force on the spring 308, controlling the engagement and disengagement of the ratchet 204 and allowing for smooth adjustment of the sliding bracket 106 according to the height of the soap dispenser.

### CROSS-REFERENCE TO RELATED APPLICATIONS

This application is a continuation in part of U.S. patent application Ser. No. 19/063,113 filed Feb. 25, 2025, which in turn, is a continuation in part of Ser. No. 18/825,150, filed on Sep. 5, 2024, which, in turn, is a continuation in part of Ser. No. 18/747,848, entitled “UTILITY HOLDER,” filed on Jun. 19, 2024, the disclosures of which are hereby incorporated in their entireties by reference thereto.

### BACKGROUND OF THE INVENTION

### 1. Field of the Invention

The present invention relates to the field of utility holders and dispensing systems, and, more particularly, to a support and locking mechanism, such as those used in soap dispensers designed to securely hold refillable containers or other variable-sized items.

### 2. Description of the Prior Art

Utility holders used for storing and securing items such as dispensers, cleaning tools, or recreational gear are commonly found in both residential and commercial environments. These holders are typically made from durable materials and designed to keep objects organized and accessible. However, many of these conventional holders are primarily focused on basic storage and lack features that address long-term functionality and maintenance.

In the case of soap dispenser holders, commonly used in homes, offices, hospitals, and public facilities, the typical approach involves mounting a dispenser in a fixed, upright position to prevent movement or spillage. While this supports convenient access, most holders are dimensionally static and cannot accommodate dispensers of varying shapes or sizes. As a result, users are often required to replace holders when switching to a different bottle design, which increases costs and reduces compatibility.

Another issue with existing soap dispenser holders is the absence of reliable security features. In shared-use environments, dispensers can be tampered with, removed, or misused, resulting in hygiene risks and increased replacement expenses. Standard holders rarely offer tamper-resistance or controlled access to mitigate problems.

Perhaps most critically, conventional utility holders, including dispenser mounts, often lack consideration for routine maintenance. These products are generally not designed for easy disassembly or deep cleaning. The build-up of soap residue, dust, or microbial deposits can compromise functionality and hygiene, especially when components are not easily accessible or removable. In many cases, internal mechanisms are sealed or obstructed, requiring specialized tools or technical expertise for basic upkeep and discouraging proper maintenance practices.

U.S. Pat. No. 12,075,954 B2 discloses a flexible mounting system for hand hygiene dispensers, comprising a dispenser holder body designed to support a product dispenser. The system includes a mounting apparatus that allows the holder body to be fixedly mounted on a support object while enabling removable attachment in multiple orientations. The dispenser holder body remains securely positioned in a selected orientation when connected to the mounting apparatus. Additionally, the system may incorporate an actuation sensor capable of detecting activations of the product dispenser.

While such known mounting systems offer orientation flexibility, they lack advanced features such as tamper resistance, secure locking, and height adjustability. Furthermore, conventional designs do not incorporate a magnetic block with an embedded magnet, nor do they provide an automated front cover locking mechanism post-cleaning. There accordingly exists a need in the art to develop a multi-functional utility holder that integrates enhanced security, adaptability, advanced locking mechanisms, and effortless maintenance, ensuring reliable usability across diverse installation environments.

### OBJECTIVES OF THE INVENTION

An objective of the present invention is to provide a secure and adjustable holding mechanism for soap dispensers or similar containers, designed to maintain the dispenser in an upright position, thereby minimizing spillage and product loss.

Another objective of the present invention is to incorporate a tamper-resistant design that prevents unauthorized access or removal of the dispenser, especially in public or shared environments.

A further objective of the present invention is to provide clear visual access for maintenance purposes while enhancing durability by utilizing robust materials for long-term functionality.

A further objective of the present is to offer adaptability by enabling the holder to accommodate containers of various shapes and sizes, eliminating the need for separate holders tailored to specific dimensions.

An additional objective of the present invention is to enhance user convenience during regular use and refilling, utilizing a sliding mechanism that allows easy access without detaching the entire unit.

Yet another objective is to provide a holder with an ergonomic, space-efficient design that can be disassembled with minimal effort for deep cleaning and maintenance.

### SUMMARY OF THE INVENTION

The present invention provides an adjustable and secure utility holder, such as for soap dispensers, that not only prevents unauthorized removal and accommodates containers of varying sizes but also facilitates regular maintenance and hygiene through its easily accessible, cleanable design.

According to an embodiment of the present invention, a utility holder for a soap dispenser comprises a fixture plate that serves as the primary mounting surface, ensuring secure attachment to a wall. A sleeve is positioned over the fixture plate, incorporating a holder bracket that provides additional structural support for the dispenser. Integrated within the sleeve is a sliding bracket that features a ratchet system, allowing it to be securely inserted and locked in place. Upon assembly, the fixture plate is enclosed within a gap formed between the sleeve and the sliding bracket, ensuring stability and controlled movement. The locking mechanism facilitates this engagement by incorporating an elongated lever with an integrally formed serpentine-shaped spring and one or more apertures. These apertures are strategically formed to couple with a movable magnetic block, which interacts with a serpentine-shaped spring to engage or disengage with a ratchet of the sliding bracket, allowing height adjustment of the sliding holder, enabling the utility holder to be adapted according to the dimensions of the soap dispenser while maintaining a firm and reliable mounting structure.

In an embodiment, the fixture plate is configured to be flat and rectangular in structure.

In another embodiment, the sleeve is configured to be hollow and rectangular in structure and includes a plurality of guiding channels for the insertion of the sliding bracket within the sleeve.

In another embodiment, one or more apertures comprise a first aperture positioned at the top end of the lever, a second aperture at the midpoint of the lever, and a third aperture at the bottom end of the lever.

In another embodiment, the first aperture is coupled to the magnetic block, while the second aperture and the third aperture are used to restrict the motion of the lever during force exertion.

In another embodiment, the ratchet of the sliding bracket comprises a plurality of teeth and a protruded tab.

In a further embodiment, the plurality of teeth is adapted to be engaged with a pawl formed at the edge of the elongated lever during the exertion of force on the lever by the movable magnetic block.

In one embodiment, the protruded tab restricts the extension of the sliding bracket and prevents complete detachment of the sliding bracket from the fixture plate.

In a further embodiment, the movable magnetic block moves back and forth in a lateral direction upon attraction via a magnetic key.

In an embodiment, the movable magnetic block includes a neodymium magnet that provides motion to the movable block due to the attraction of the magnetic key.

In another embodiment, the height of the holder is adjusted accordingly to the height of the soap dispenser to be secured between the holding bracket and sliding bracket.

In a further embodiment, the holding bracket is size-adjustable to accommodate a wine bottle.

In yet another embodiment, the sliding bracket further includes an auxiliary key aperture to receive an auxiliary key for disassembling the internal components of the holder for cleaning and maintenance purposes.

### BRIEF DESCRIPTION OF THE DRAWINGS

The invention will be more fully understood, and further advantages will become apparent when reference is had to the following detailed description and the accompanying drawings, in which

FIG. 1A illustrates a perspective view of a utility holder in accordance with an embodiment of the present invention;

FIG. 1B is a cross-sectional view taken through the line A-A of FIG. 1A;

FIGS. 2A and 2 B illustrate an enlarged perspective view of the sleeve and the sliding bracket of the utility holder in accordance with an embodiment of the present invention;

FIG. 3A-3C illustrates a front view of the fixture plate of the utility holder along with an engaged and disengaged state of the locking mechanism associated with the utility holder in accordance with an embodiment of the present invention;

FIGS. 4A and 4B illustrate enlarged views of the disassembling mechanism of the utility holder, in accordance with an embodiment of the present invention; and

FIGS. 5A. 5B and 5C illustrate perspective views of a utility holder, in accordance with the invention.

### DETAILED DESCRIPTION OF THE INVENTION

The embodiments herein and the various features and advantageous details thereof are explained more fully with reference to the non-limiting embodiments that are illustrated in the accompanying drawings and the following description. Numerous variations, changes, and substitutions may occur to those skilled in the art without departing from the invention. It should be understood that various alternatives to the embodiments of the present disclosure herein may be employed.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Furthermore, the present techniques are not limited by the terms used in the application, as all equivalents, synonyms, new developments, and terms or techniques that serve the same or a similar purpose are considered to be within the scope of the present claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

The present invention relates to a utility holder configured to securely accommodate liquid soap dispenser bottles of varying sizes, offering both height adjustability and tamper resistance. The utility holder is designed to maximize space efficiency, enhance user convenience, and prevent unauthorized removal in both public and private settings.

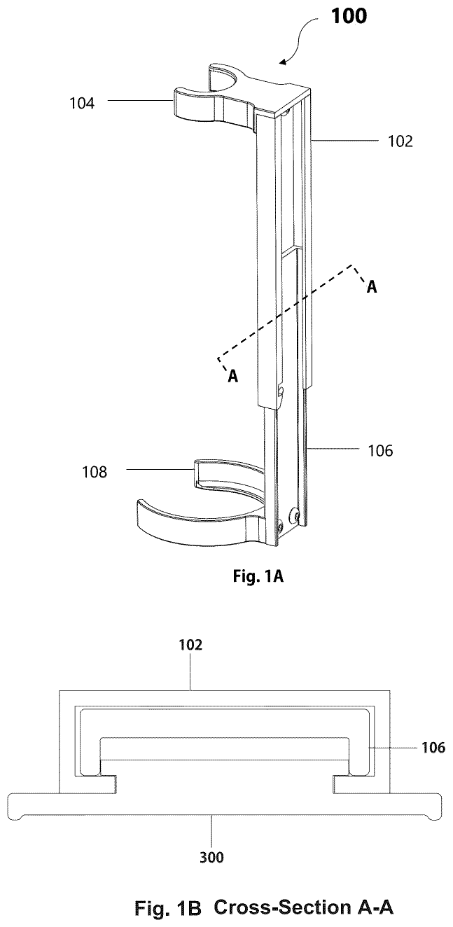

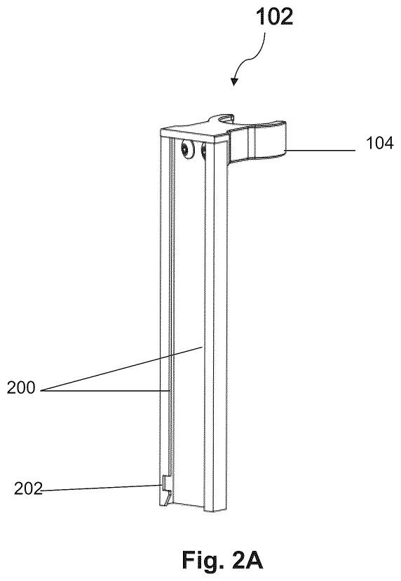

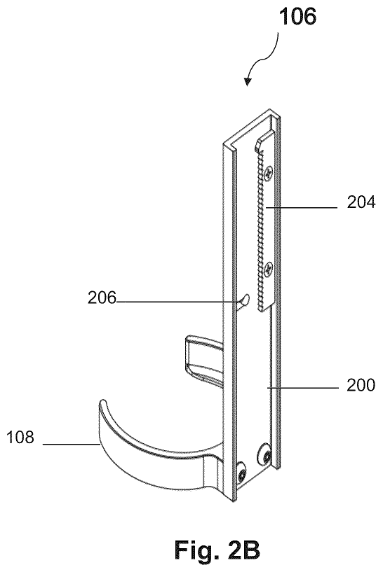

FIG. 1 illustrates a perspective view of a utility holder 100 for a soap dispenser. The utility holder 100 comprises a sleeve 102 equipped with a holder bracket 104. The sleeve 102 is adapted to be positioned onto a fixture plate (not shown) and configured to be secured to a wall, providing structural stability to the sleeve 102 of the utility holder 100. A sliding bracket 106 is configured to be inserted within sleeve 102 to engage within the fixture plate via a ratchet 204 (as shown in FIG. 2B) equipped within the sliding bracket 106. A fixture clamp 108 is fastened to the end of the sliding bracket 106, thereby forming a complete assembly of the utility holder 100 which allows for the accommodation of the soap dispenser bottle.

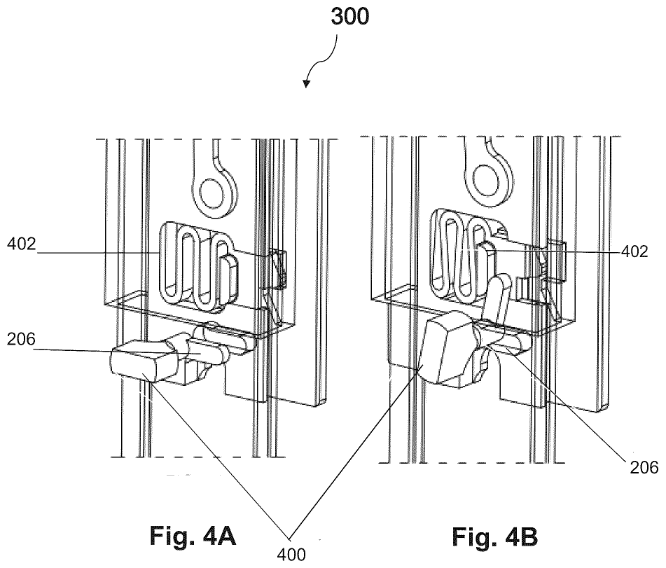

FIGS. 2A and 2 B illustrate an enlarged perspective view of the sleeve and the sliding bracket associated with the utility holder. The aforementioned figures depict the structural orientation of the sleeve 102 and the sliding bracket 106. The sleeve 102, shown here, has an elongated, hollow, rectangular-shaped structure configured to receive the sliding bracket 106 via a plurality of guiding channels 200, which allows for easy and smooth insertion of the sliding bracket 106 within the sleeve 102. The sleeve 102 is made of any material selected from, but not limited to, metallic, plastic, or wooden materials, providing robustness or rigidity to the utility holder 100. A notch 202 is formed at the end of one of the guiding channel 200 to lock sleeve 102 with the sliding bracket 106. An axillary key-aperture 206 is provided in the sliding bracket 106 and adapted to be utilized for disassembling the utility holder 100 via an auxiliary key (as shown in FIGS. 4A and 4B), which is operated manually for cleaning and maintenance purposes.

On the top end of sleeve 102, the holder bracket 104 is attached to grip a top portion of the soap dispenser bottle. The bottom portion of the soap dispenser bottle is secured with the fixture clamp 108 attached to the bottom end of the sliding bracket 106 (as shown in FIGS. 2A and 2B). This, in turn, provides support to the accommodated soap dispenser bottle upon the insertion of the sliding bracket 106 within sleeve 102. Thus, providing stabilization to the accommodated soap dispensers. In an embodiment, the holding bracket 104 is attached to the sleeve 102 via a plurality of screws, nuts, and/or fasteners.

In an embodiment, the holder bracket 104 herein comprises a semi-circular shape whereas the fixture clamp has a circular plate or a ring-like structure (as illustrated in FIG. 1) to firmly grip the soap dispenser.

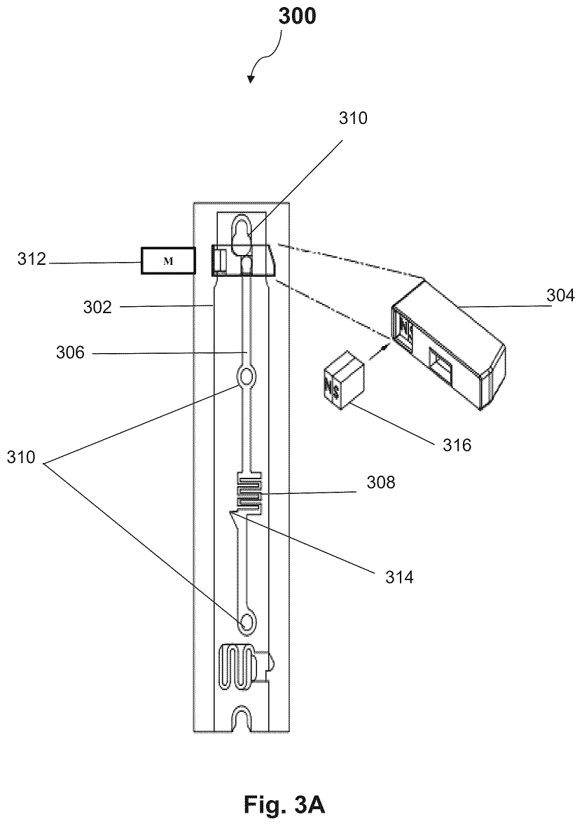

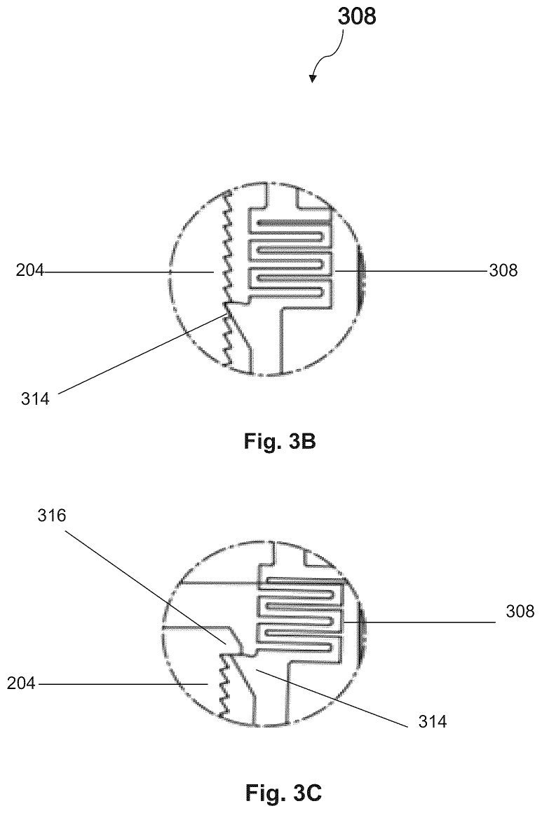

FIG. 3A illustrates a front view of the fixture plate equipped with a locking mechanism 302 along with several internal components associated with said locking mechanism. The fixture plate 300 disclosed herein comprises a flat, rectangular-shaped structure configured to be mounted to a wall using various fasteners. In an embodiment, the fasteners may include screws, nuts and bolts, nails, and the like.

Referring to FIG. 1B, there is shown a cross-sectional view of the fixture plate 300, taken along line A-A of FIG. 1A. Fixture plate 300 is secured to the wall in such a manner that when sleeve 102 is mounted over the fixture plate 300, and the sliding bracket 106 is simultaneously inserted within sleeve 102, a small gap or spacing is formed between sleeve 102 and the sliding bracket 106 which allows convenient accommodation of the fixture plate 300 therebetween. In other words, the fixture plate 300 is sandwiched between the sleeve 102 and sliding bracket 106 to provide stability to both the sleeve 102 and the sliding bracket 106.

Upon positioning the fixture plate 300 within the gap, the sliding bracket 106 is enclosed within sleeve 102 and locked due to the engagement of a plurality of teeth of the ratchet 204 and the locking mechanism 302 of the fixture plate 300. This, in turn, facilitates secure height adjustment and tamper-resistant locking of the utility holder 100.

Furthermore, in FIG. 3A, the locking mechanism disclosed here comprises an elongated lever 306 with an integrally formed serpentine-shaped spring 308 and one or more apertures 310. In an embodiment, one or more apertures 310 comprises a first aperture located at the top end of the lever 306. A second aperture is at the midpoint of the lever, and a third aperture is located at the bottom end of lever 306. The first aperture is configured to be coupled with a movable magnetic block 304, integrated with the locking mechanism 302. The other two apertures are configured to be pivoted at the end and midpoint of the lever 306. The attachments of the elongated lever 306 and magnetic block 304 are arranged in a manner such that when a magnetic key 312 (indicated by M) is positioned in proximity to the sleeve 102, the movable magnetic block 304, due to the magnetic attraction of the magnetic key 312, moves in a back and forth motion in a lateral direction.

This, in turn, tilts the elongated lever 306 to exert a force on the serpentine-shaped spring 308 to engage or disengage a pawl 314 formed at an edge of the lever 306 with the plurality of teeth of the ratchet 204. Thereby locking the sliding bracket 106 within the sleeve 102 to keep the soap dispenser locked in place. In an embodiment, the height of the utility holder 100 is adjusted according to the height of the soap dispenser to be secured between the holder bracket 104 and sliding bracket 106. The elongated lever 306 and serpentine-shaped spring 308 are typically made of stainless steel. In an embodiment, the serpentine-shaped spring 308 is made of plastic.

In another embodiment, the movable magnetic block 304 comprises a neodymium magnet 316 that aids in the movement of the magnetic block 304 towards the magnetic key 312, facilitating the engagement and disengagement of the teeth of the ratchet 204 and the pawl 314. In a further embodiment, the neodymium magnet 316 is strategically aligned within the movable magnetic block 304 for precise engagement or disengagement of pawl 314 and the ratchet 204.

In an embodiment, the tilting of the elongated lever 306 engages or disengages the ratchet 204 of the sliding bracket 106, allowing adjustment of the height of the sliding holder 100 according to the dimensions of the soap dispenser (as shown in FIGS. 3B-3C).

FIGS. 3B-3C illustrate an engaged state of the pawl 314 and ratchet 204 of the sliding bracket 106 with no extension and complete extension of the sliding bracket 106. FIGS. 3B-3C depict how the pawl 314 is engaged with the plurality of teeth of the ratchet 204. Furthermore, FIGS. 3B-3C depict a protruded tab 316 of the ratchet 204, which restricts the extension of the sliding bracket 106 to a specific length. The geometry between the pawl 314 and ratchet 204 allows the sliding bracket 106 to be easily pushed upward but prevents the downward slippage once locked. This height-locking function provides stability, adjustability, and provision for mounting various-sized dispensers.

In an embodiment, the protruded tab on the ratchet 204 serves as a stopper, preventing the sliding bracket 106 from fully exiting the sleeve 102.

FIGS. 4A and 4B demonstrate the states of disassembly of the utility holder for deep cleaning and maintenance purposes. Specifically, FIGS. 4A and 4B depict the auxiliary key 400 inserted within the auxiliary key aperture 206, which is exposed appropriately when the sliding bracket 106 is completely lowered. When the sliding bracket 106 moves all the way down to the extreme opening end, the auxiliary key aperture 206 becomes visible and is adapted to receive the auxiliary key 400.

The auxiliary key 400, upon insertion in the key aperture 206, is required to be turned in a counter-clockwise direction to push a lock spring 402 to the left; this unlocks a cover (not shown) of the sleeve 102 and allows the sliding bracket 106 to slide downward and the sleeve 102 to move in an upward direction. With this arrangement, sleeve 102 and sliding bracket 106 can be separated completely.

Similarly, the utility holder 100 is reassembled by simply sliding sleeve 102 over the fixture plate 300 to lock it in place until the Lock Spring (10) clicks into a designated locking position. Then slide the sliding bracket within sleeve 102, from the bottom until the pawl 314 engages with the Ratchet 204. This, in turn, locks the soap dispenser within the utility holder 100.

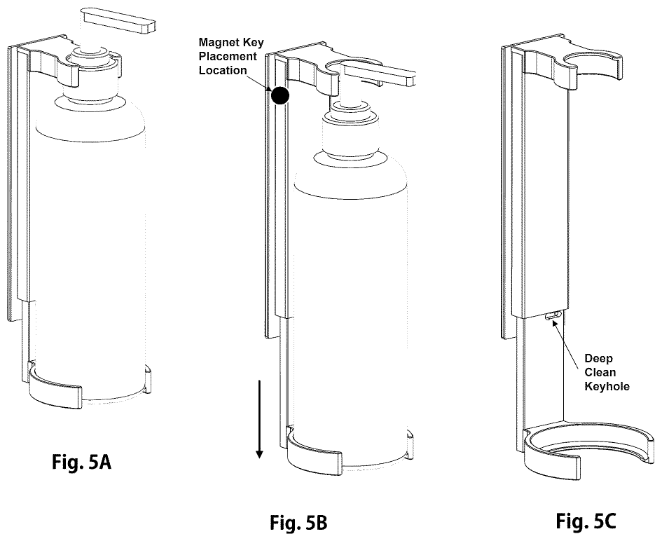

Referring to FIGS. 5A, 5B and 5C, there is shown, the mechanism that allows the movement of liquid soap bottles up and down using a ratchet lock/unlock system. The spring-loaded Pawl engages in a linear ratchet with a built-in spring force to lock the slide into position. When the magnet key is placed at the correct location (as shown in FIG. 5B), it disengages the ratchet by unlocking the slide, allowing for free downward movement. The spring-loaded pawl, engaged with the linear ratchet, provides the appropriate amount of force to safely support the object's weight. In this embodiment, the weight is the weight of the filled bottle of liquid soap. The ratchet slide can also be used to support or secure various other types of liquid-containing products.

A Magnet block is made by inserting a magnet into injection-molded plastic and then sealing the surface with epoxy to ensure corrosion resistance. The location of the Magnet block and disengagement of the ratchet using the magnet key are essential security features. The mechanism allowing the movement of liquid soap bottles up and down can only be disengaged (opened) if the magnet key is placed in the exact location. The opposing forces of the spring-loaded Pawl and magnet allow the Pawl to engage and disengage from the ratchet mounted on the Slider. When the magnet key is placed, the magnet block is attracted toward the magnet key, overcoming spring force and disengaging the Pawl from the linear ratchet. Once the Pawl is disengaged from the linear ratchet, the soap bottle slides downward along with its holder and Slider, allowing the bottle to be removed for refilling (as shown in FIG. 5C). Another key feature of this design is deep clean access. Once the Slider is fully down, the keyhole becomes visible (as shown in FIG. 5C), allowing a key to be inserted, which enables the disassembly of the front cover for a thorough cleaning of the entire mechanism.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within understood that the phraseology or the terminology employed herein is for description and not of limitation. Therefore, while the embodiments herein have been described in terms of preferred embodiments, those skilled in the art will recognize that the embodiments herein can be practiced with modification within the spirit and scope of the appended claims.\

The advantages set forth above, and those made apparent from the foregoing description, are efficiently attained. Since certain changes may be made in the above construction without departing from the scope of the invention, it is intended that all matters contained in the foregoing description be interpreted as illustrative and not in a limiting sense.

It is also to be understood that the following claims are intended to cover all the generic and specific features of the invention herein described, and all statements of the scope of the invention that, as a matter of language, might fall therewithin.

Having thus described the invention in rather full detail, it will be understood that such detail need not be strictly adhered to but that further changes and modifications may suggest themselves to one skilled in the art, all falling within the scope of the invention as defined by the subjoined claims

What is claimed is:

1. A utility holder for a soap dispenser, comprising:
a fixture plate adapted to be secured to a wall;
a sleeve having a holder bracket adapted to be placed over the fixture plate;
a sliding bracket integrated with a ratchet adapted to be inserted within the sleeve,
wherein upon placement of the sleeve and insertion of the sliding bracket, the fixture plate is enclosed within a gap formed between the sleeve and the sliding bracket to lock the sliding bracket within the sleeve via a locking mechanism,
wherein the locking mechanism comprises an elongated lever having an integrally formed serpentine-shaped spring and one or more apertures,
wherein said one or more apertures are configured to couple with a movable magnetic block that exerts a force on the serpentine-shaped spring to engage or disengage the ratchet of the sliding bracket, allowing adjustment of the height of the sliding holder according to the dimensions of the soap dispenser.

2. The utility holder of claim 1, wherein the fixture plate is shaped flat and rectangular in structure.

3. The utility holder of claim 1, wherein said sleeve is shaped hollow and rectangular in structure and includes a plurality of guiding channels for insertion of the sliding bracket within the sleeve.

4. The utility holder of claim 1, wherein the one or more apertures comprises a first aperture positioned at a top end of the lever, a second aperture at a midpoint of the lever and a third aperture at a bottom end of the lever.

5. The utility holder of claim 4, wherein the first aperture is configured to couple with the magnetic block, while the second aperture and the third aperture are utilized to restrict the motion of the lever during exertion of force.

6. The utility holder of claim 1, wherein the ratchet of the sliding bracket comprises a plurality of teeth and a protruded tab.

7. The utility holder of claim 6, wherein the plurality of teeth is adapted to be engaged with a pawl formed at an edge of the elongated lever during the exertion of force on the lever by the movable magnetic block.

8. The utility holder of claim 6, wherein the protruded tab restricts extension of the sliding bracket and prevents complete detachment of the sliding bracket from the fixture plate.

9. The utility holder of claim 1, wherein the movable magnetic block moves back and forth in a lateral direction upon attraction via a magnetic key.

10. The utility holder of claim 9, wherein the movable magnetic block includes a pair of neodymium magnets that provide motion to the movable block due to the attraction of the magnetic key.

11. The utility holder of claim 1, wherein the height of the holder is adjusted according to the height of the soap dispenser to be secured between the holding bracket and sliding bracket.

12. The utility holder of claim 1, wherein the holder bracket has a semi-circular shape, is configured to grip a head cap of the soap dispenser.

13. The utility holder of claim 1, wherein the sliding bracket further comprises an auxiliary key aperture configured to receive an auxiliary key for disassembling the internal components of the holder for cleaning and maintenance purposes.

14. The utility holder of claim 1, wherein the serpentine-shaped spring is composed of plastic.
